(19) United States
(12) Patent Application Publication
(10) Pub. No.: US 2014/0339042 A1
(43) Pub. Date: Nov. 20, 2014

(54) TORQUE CONVERTER

(71) Applicant: EXEDY Corporation, Neyagawa-shi, Osaka (JP)

(72) Inventors: Masakatsu Togawa, Neyagawa-shi (JP); Ken Mototsune, Neyagawa-shi (JP)

(21) Appl. No.: 14/360,538

(22) PCT Filed: Dec. 11, 2012
(86) PCT No.: PCT/JP2012/082093

§ 371 Date: May 23, 2014

(30) Foreign Application Priority Data
Dec. 14, 2011 (JP) 2011-273003

(51) Int. Cl. F16H 41/28; F16H 45/02; F16H 41/04

(52) U.S. Cl. CPC F16H 41/28; F16H 41/04; F16H 45/02
USPC 192/3.29; 60/361

(57) ABSTRACT

A torque converter includes a front cover, an impeller, a turbine and a stator. The impeller includes an impeller shell coupled to the front cover, a plurality of impeller blades disposed inside the impeller shell, and an impeller hub. The impeller hub is formed in an axially extending tubular shape, while being fixed at an engine-side end part thereof to the inner peripheral part of the impeller shell by means of friction welding. The impeller hub also has a burr produced by the friction welding.

### CROSS-REFERENCE TO RELATED APPLICATIONS

This application is a U.S. National stage application of International Application No. PCT/JP2012/082093, filed Dec. 11, 2012, which claims priority to Japanese Patent Application No. 2011-273003, filed in Japan on Dec. 14, 2011, the entire contents of which are hereby incorporated by reference.

### BACKGROUND

1. Field of Invention

The present invention relates to a torque converter configured to transmit torque from an engine by means of fluid.

2. Background Information

A torque converter is a device configured to transmit torque from an engine toward a transmission through operating fluid filled in the inside thereof. The torque converter is mainly composed of a front cover, an impeller, a turbine and a stator. The front cover is a member that is coupled to an engine-side member and into which torque is inputted from the engine. The impeller is connected to the front cover, whereas the turbine is disposed in opposition to the impeller. The stator is disposed between the inner peripheral part of the impeller and that of the turbine to regulate the flow of the operating fluid directed from the turbine to the impeller. Here, torque inputted into the impeller from the front cover is transmitted to the turbine from the impeller through the operating fluid, and is then outputted from the turbine toward the transmission.

Now in focusing on an impeller structure, for instance, an impeller of a torque converter described in Japanese Laid-open Patent Application Publication No. JP-A-2011-122640 includes an impeller shell, a plurality of impeller blades and an impeller hub. The impeller shell is coupled to the front cover, while the impeller blades are disposed inside of the impeller shell. Further, the impeller hub axially extends in a tubular shape, and the engine-side end part thereof is fixed to the inner peripheral part of the impeller shell by welding.

Further, the torque converter is equipped with a lock-up device for enhancing efficiency of torque transmission. The lock-up device is disposed in a space produced between the turbine and the front cover. The lock-up device is configured to directly transmit torque from the front cover to the turbine by mechanically coupling the front cover and the turbine in a region that a function of the torque converter is not required.

The lock-up device described in Japanese Laid-open Patent Application Publication No. JP-A-2011-122640 includes a piston configured to be pressed onto a friction surface of the front cover; an output-side member fixed to the turbine; and a plurality of torsion springs configured to elastically couple the piston and the output-side member.

### SUMMARY

In an impeller of a well-known torque converter as described in the above mentioned Japanese Publication, the impeller shell and the impeller hub are fixed by friction welding. Further, in performing friction welding, the impeller hub is press-contacted to the impeller shell while being in friction therewith. Burrs are thereby produced on the tip end part of the impeller hub. Therefore, the burrs are required to be removed in a subsequent manufacturing step, and it has been demanded to simplify the manufacturing processing.

On the other hand, the plural impeller blades are fixed to the inner peripheral surface of the impeller shell by means of brazing. However, “a brazing metal” as a filler material for brazing is expensive. Further, the impeller is required to be fed into a furnace for brazing. Thus, it takes a long time to manufacture the impeller.

As described above, many torque converters are equipped with the lock-up device, and a piston of the lock-up device is slid with other members. Therefore, the piston is processed with nitriding to enhance the hardness of the piston surface, and accordingly, to inhibit abrasion of the piston. The nitriding is time-consuming and also results in an increase in manufacturing cost.

It is an object of the present invention to manufacture an impeller at a low cost.

It is another object of the present invention to manufacture a lock-up device including a piston at a low cost.

A torque converter according to a first aspect of the present invention includes a front cover coupled to an engine-side member; an impeller into which a torque from the front cover is inputted; a turbine disposed in opposition to the impeller; and a stator disposed between an inner peripheral part of the impeller and an inner peripheral part of the turbine and configured to control a flow of an operating fluid flowing from the turbine to the impeller. The impeller includes an impeller shell coupled to the front cover; a plurality of impeller blades disposed inside the impeller shell; and an impeller hub. The impeller hub is formed in an axially extending tubular shape while being fixed at an engine-side end part thereof to an inner peripheral part of the impeller shell by friction welding, and also has a burr produced by the friction welding.

Here, the impeller hub is fixed to the impeller shell by friction welding. Further, the burr produced in performing the friction welding remains in status quo. In other words, a manufacturing step of removing the burr is not required in the present torque converter. It is thereby possible to manufacture the impeller at a low cost.

A torque converter according to a second aspect of the present invention relates to the torque converter of the first aspect, and wherein the impeller shell has an inner peripheral extending portion that is formed on an inner peripheral end thereof to extend to a further inner peripheral side than an inner peripheral surface of the impeller hub. The inner peripheral extending portion restricts the burr produced by frictionally welding the impeller hub to the impeller shell from being produced on an engine side across the impeller shell.

The burr is produced on the tip end part of the impeller hub by frictionally welding the impeller shell and the impeller hub. When entering the engine side, the burr may interfere with another member.

In view of the above, in the torque converter of the second aspect, the inner peripheral extending portion is formed on the inner peripheral end part of the impeller shell, and thereby, the burr produced on the tip end part of the impeller hub is restricted from entering the engine side. Therefore, it is possible to avoid such a situation that the burr produced by friction welding interferes with another member.

A torque converter according to a third aspect of the present invention relates to the torque converter of the first or second aspect, and wherein the front cover has a friction surface on an impeller-side lateral surface thereof. Moreover, the torque converter further includes a lock-up device that is disposed between the front cover and the turbine and directly transmits the torque from the front cover to the turbine. The lock-up device includes a piston, an output-side member and an elastic member. The piston has a friction member configured to be pressed onto the friction surface of the front cover, and is configured to be axially movable. The output-side member is fixed to the turbine. The elastic member elastically couples the piston and the output-side member in a rotational direction. Furthermore, the piston only partially has a part processed with surface hardening, and the processed part is configured to be slid with another member.

Here, the piston is not entirely processed with surface hardening but is partially processed, i.e., the part configured to be slid is processed with surface hardening, such as nitriding. Therefore, the processing time can be reduced in comparison with that required so far, and cost reduction is enabled.

A torque converter according to a fourth aspect of the present invention relates to the torque converter of the third aspect, and wherein the friction surface of the front cover is not processed with polishing.

The friction surface of a well-known front cover is processed with polishing after cutting. Therefore, this requires a long processing time and results in increase in manufacturing cost.

In view of the above, in the present torque converter of the fourth aspect, cutting is only performed for the friction surface of the front cover, whereas polishing performed so far is abolished. Therefore, it is possible to achieve reduction in processing time and reduction in manufacturing cost.

A torque converter according to a fifth aspect of the present invention relates to the torque converter according to any of the first to fourth aspects, and wherein the plural impeller blades have a plurality of protrusions on impeller-shell side outer peripheral parts thereof, while the impeller shell has recessed portions, into which the protrusions are inserted, on an inner peripheral surface thereof, and the impeller blades are fixed to the impeller shell by swaging lateral parts of the recessed portions.

Here, the protrusions of the impeller blades are inserted into the recessed portions formed on the inner peripheral surface of the impeller shell, and the recessed portions and the vicinity thereof are swaged. Accordingly, the impeller blade is fixed to the impeller shell.

Hence, the impeller blade is not required to be brazed to the impeller shell. Therefore, it is possible to achieve reduction in processing time and reduction in manufacturing cost.

According to the present invention as described above, it is possible to achieve a reduction in processing time and a reduction in manufacturing cost.

### BRIEF DESCRIPTION OF THE DRAWINGS

FIG. 1 is a vertical cross-sectional structural view of a torque converter employing an exemplary embodiment of the present invention.

FIG. 2 is a partial enlarged view of FIG. 1.

FIG. 3 is a vertical cross-sectional structural view of a lock-up device of FIG. 1.

FIG. 4 is a front view of the lock-up device of FIG. 3.

### DESCRIPTION OF THE EXEMPLARY EMBODIMENTS

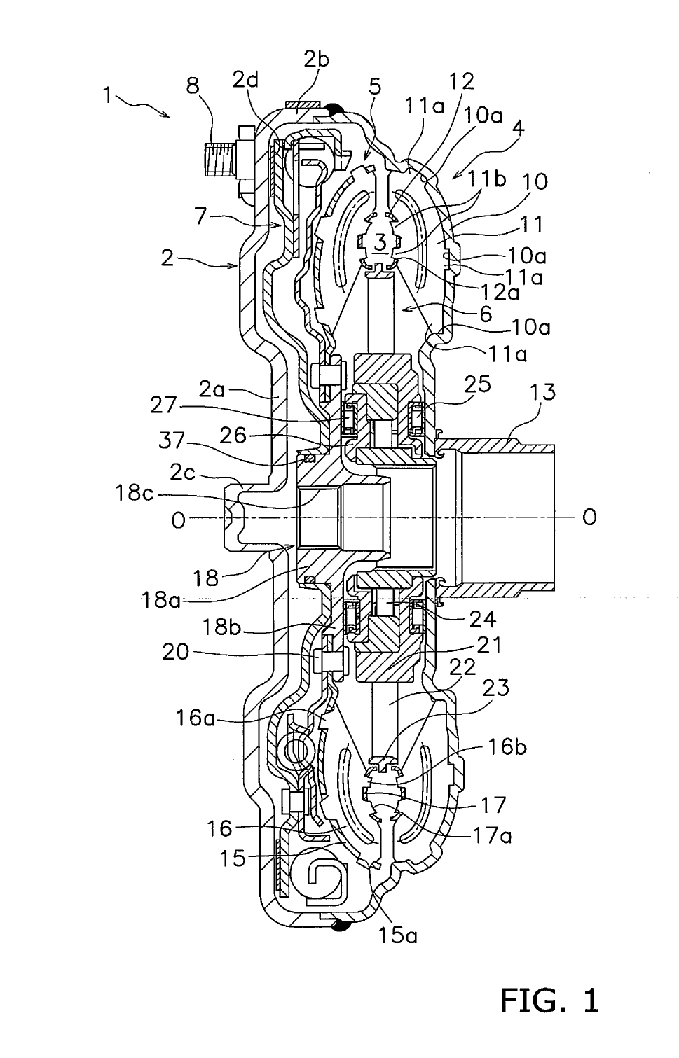

FIG. 1 illustrates a torque converter 1 according to an exemplary embodiment of the present invention. The torque converter 1 is a device for transmitting torque from an engine to an input shaft of a transmission. In FIG. 1, the engine (not illustrated in the drawing) is disposed on the left side, whereas the transmission (not illustrated in the drawing) is disposed on the right side. A line O-O depicted in FIG. 1 indicates a rotary axis of the torque converter 1.

The torque converter 1 includes a front cover 2, an impeller 4, a turbine 5 and a stator 6, and these components form a torque converter main body. Further, the torque converter 1 is equipped with a lock-up device 7. Yet further, the impeller 4, the turbine 5 and the stator 6 form a fluid actuation chamber 3 having a torus shape.

The front cover 2 is a member to which torque is inputted through a flexible plate (not illustrated in the drawings). The front cover 2 has a disc portion 2a and a tubular portion 2b extending from the outer peripheral edge of the disc portion 2a toward the transmission. Further, the front cover 2 has a center boss 2c disposed in the center part thereof The center boss 2c is an axially extending tubular member, and is inserted into the inside of a center hole of a crankshaft.

The disc portion 2a has a friction surface 2d formed on the outer peripheral part of the transmission-side lateral surface thereof. In a well-known device, polishing has been performed for the friction surface 2d. By contrast, in the present exemplary embodiment, only cutting is performed for the friction surface 2d without performing polishing. Further, in a well-known device, cutting has been performed for a part other than the friction surface 2d on the transmission-side lateral surface of the disc portion 2a to avoid interference with the other members. By contrast, such cutting is not herein performed.

Further, a plurality of bolts 8 are fixed to the outer peripheral part of the engine-side lateral surface of the disc portion 2a by means of welding. The flexible plate (not illustrated in the drawings) is attached to the disc portion 2a through the bolts 8. It should be noted that similarly, cutting is not performed for the part to which the bolts 8 are fixed.

The impeller 4 is mainly composed of: an impeller shell 10; a plurality of impeller blades 11 fixed to the inside of the impeller shell 10; an impeller core 12; and an impeller hub 13 fixed to the inner peripheral part of the impeller shell 10.

The outer peripheral part of the impeller shell 10 is welded to the tip end part of the tubular portion 2b of the front cover 2. The impeller shell 10 has a plurality of recessed portions 10a on the inner surface (i.e., the turbine-side surface) to fix the impeller blades 11. It should be noted that each one of the impeller blades 11 has three recessed portions 10a respectively formed on its outer peripheral side part, its radially middle part and its inner peripheral side part.

Each impeller blade 11 is a plate-shaped member, and has a plurality of protrusions 11a formed on the transmission-side outer peripheral edge thereof while having a plurality of protrusions 11b formed on the engine-side inner peripheral edge thereof. Three protrusions 11a formed on the outer peripheral edge are respectively inserted into the recessed portions 10a of the impeller shell 10, and the recessed portions 10a are swaged. Thus, each impeller blade 11 is fixed to the impeller shell 10. On the other hand, two protrusions 11b formed on the inner peripheral edge are inserted into two cutouts 12a formed in the impeller core 12.

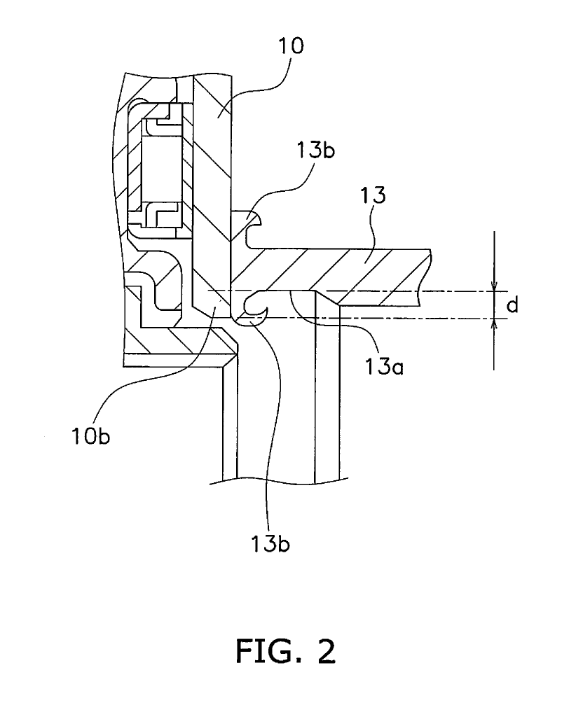

The impeller hub 13 is a tubular member, and the engine-side tip end thereof is welded to the inner peripheral end part of the impeller shell 10 by means of friction welding. As illustrated in an enlarged view of FIG. 2, an extending portion 10b is formed on the inner peripheral end part of the impeller shell 10, while further inwardly extending from an inner peripheral surface 13a of the impeller hub 13 by a distance d. As illustrated in FIGS. 1 and 2, when the impeller hub 13 is herein frictionally welded, burrs 13b are produced on the tip end part of the impeller hub 13. Chances are that the burrs 13b produced on the inner peripheral side of the impeller hub 13 interfere with other members when being formed and extending toward the engine. However, the impeller shell 10 has the extending portion 10b formed on the inner peripheral end part thereof. Therefore, the extending portion 10b prevents the burrs 13b from entering the engine side.

The turbine 5 is disposed axially in opposition to the impeller 4 within a fluid chamber. The turbine 5 is mainly composed of a turbine shell 15, a plurality of turbine blades 16, a turbine core 17 and a turbine hub 18 fixed to the inner peripheral part of the turbine shell 15.

A plurality of cutouts 15a are formed in the turbine shell 15, whereas a plurality of cutouts 17a are formed in the turbine core 17. Each turbine blade 16 is a plate-shaped member, and has a plurality of protrusions 16a formed on the outer peripheral edge thereof while having a plurality of protrusions 16b formed on the inner peripheral edge thereof. Further, the protrusions 16a are respectively inserted into the cutouts 15a of the turbine shell 15, while the protrusions 16b are respectively inserted into the cutouts 17a of the turbine core 17. Thus, the turbine blades 16 are fixed.

The turbine hub 18 is disposed in the inner peripheral part of the turbine shell 15, and has a tubular portion 18a extending in the axial direction, and a flange portion 18b extending from the tubular portion 18a to the outer peripheral side. The inner peripheral part of the turbine shell 15 is fixed to the flange portion 18b of the turbine hub 18 by a plurality of rivets 20. Further, a spline hole 18c, with which the input shaft is engaged, is formed in the inner peripheral part of the tubular portion 18a of the turbine hub 18.

The stator 6 is a mechanism for regulating the flow of operating oil returning to the impeller 4 from the turbine 5. The stator 6 is integrally made of resin, aluminum alloy or so forth by forging. The stator 6 is mainly composed of a stator carrier 21 formed in an annular shape, a plurality of stator blades 22 mounted to the outer peripheral surface of the stator carrier 21, and a stator core 23 mounted to the outer peripheral side of the stator blades 22. The stator carrier 21 is supported by a stationary shaft (not illustrated in the drawings) formed in a tubular shape through a one-way clutch 24.

It should be noted that a first thrust bearing 25 is mounted between the inner peripheral part of the impeller shell 10 and the stator carrier 21. A support member 26 and a second thrust bearing 27 are mounted between the one-way clutch 24 and the flange portion 18b of the turbine hub 18.

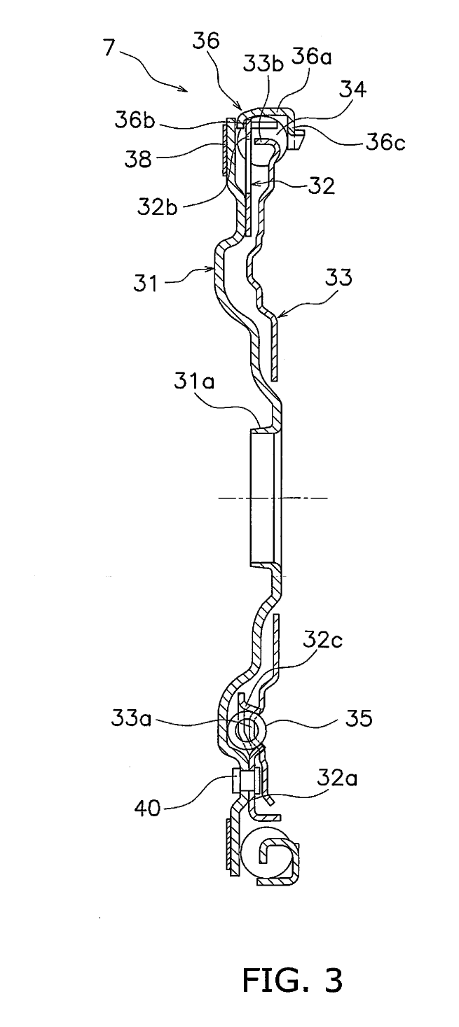

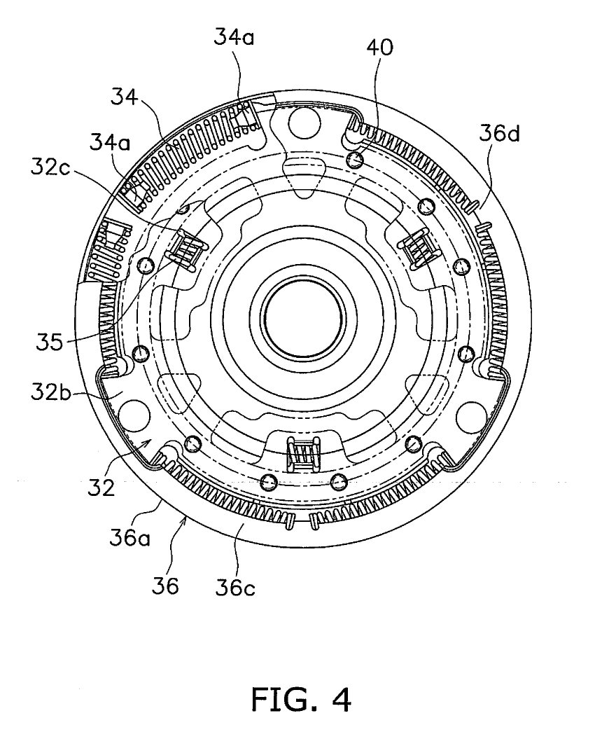

FIGS. 3 and 4 illustrate the lock-up device 7 extracted from the entirety. The lock-up device 7 is a mechanism disposed in a space produced between the turbine 5 and the front cover 2 and configured to mechanically couple both components on an as-needed basis.

The lock-up device 7 is mainly composed of a piston 31, a retaining plate 32, a driven plate 33, a plurality of first torsion springs 34, a plurality of second torsion springs 35 and a support member 36.

The piston 31 is a plate member formed in a disc shape, and has a tubular portion 31a in the center part thereof. The tubular portion 31a is supported by the tubular portion 18a of the turbine hub 18 to be axially movable. It should be noted that a seal member 37 (see FIG. 1) is mounted to the tubular portion 18a of the turbine hub 18, and seals between the tubular portion 31a of the piston 31 and the tubular portion 18a of the turbine hub 18. Further, a friction member 38 formed in an annular shape is fixed to the outer peripheral part of the piston 31. It should be noted that nitriding is performed as surface hardening for the parts of the piston 31 that are configured to be slid with the other members. Specifically, the nitriding is performed for a part configured to be slid with the first torsion springs 34, a part configured to be slid with the second torsion springs 35, and a part configured to be slid with the flange portion 18b of the turbine hub 18.

The retaining plate 32 is a member formed in an annular shape, and has a fixation portion 32; three support portions 32b formed at equal angular intervals, and spring accommodation portions 32c. The fixation portion 32a is fixed to the piston 31 by a plurality of rivets 40. The support portions 32b are formed to protrude from the fixation portion 32a to the outer peripheral side, and support the circumferential end parts of the first torsion springs 34. The spring accommodation portions 32c are formed on the inner peripheral side of the fixation portion 32a, and accommodate the second torsion springs 35 therein.

The driven plate, or output-side member, 33 is a member formed in an annular shape, and the inner peripheral part thereof is fixed together with the turbine shell 15 to the flange portion 18b of the turbine hub 18 by the plural rivets 20. Further, three window holes 33; in which the second torsion springs 35 are disposed, are formed roughly in a radially middle part of the driven plate 33. Circumferential support portions 33b are formed on the outer peripheral end part of the driven plate 33, while being bent toward the engine.

The circumferential support portions 33b on the outer peripheral side are configured to be contactable to the circumferential end parts of the first torsion springs 34. Further, two first torsion springs 34, disposed in series, are compressed between the circumferential support portions 33b of the driven plate 33 and the outer peripheral side support portions 32b of the retaining plate 32. The circumferential end parts of each window hole 33a are configured to be contactable to the circumferential end parts of each second torsion spring 35. Yet further, each second torsion spring is compressed between the circumferential end parts of each window hole 33a of the driven plate 33 and each spring accommodation portion 32c of the retaining plate 32.

The first torsion springs 34 transmit torque between the piston 31 and the driven plate 33 through the retaining plate 32. In the present exemplary embodiment, three pairs of first torsion springs 34 (i.e., six first torsion springs 34) are circumferentially disposed in alignment. Each pair of first torsion springs 34 is composed of two first torsion springs 34. As illustrated in FIG. 4, spring sheets 34a are disposed on the both circumferential end parts of each first torsion spring 34.

The second torsion springs 35 transmit torque between the retaining plate 32 and the driven plate 33. The three second torsion springs 35 are circumferentially disposed in alignment on the inner peripheral side of the first torsion springs 34.

The support member 36 is a member for supporting the outer peripheral side parts of the first torsion springs 34, and is disposed to be rotatable relative to the retaining plate 32 and the driven plate 33. The support member 36 has an outer peripheral support portion 36a, a first axial restriction portion 36b (see FIG. 3), a second axial restriction portion 36c and spring support portions 36d (see FIG. 4).

The outer peripheral support portion 36a is a portion for supporting the outer peripheral side parts of the first torsion springs 34, and prevents the first torsion springs 34 from jumping out to the outer peripheral side.

The first axial restriction portion 36b is formed on the engine-side end part of the outer peripheral support portion 36a to protrude to the inner peripheral side. The first axial restriction portion 36b is disposed between the outer peripheral end part of the piston 31 and that of the retaining plate 32. Accordingly, the support member 36 is restricted from axially moving.

The second axial restriction portion 36c is a portion for restricting the first torsion springs 34 from moving toward the transmission, and is formed on the transmission-side end part of the outer peripheral support portion 36a to protrude to the inner peripheral side.

As illustrated in FIG. 4, the spring support portions 36d are portions capable of supporting the circumferential end parts of the first torsion springs 34, and each of them is disposed circumferentially between two first torsion springs 34 disposed adjacently to each other.

In a low speed range, the lock-up device is turned off (clutch is disengaged), and torque from the engine is transmitted to the impeller 4 from the front cover 2. Further, the torque inputted into the impeller 4 is transmitted to the turbine 5 from the impeller 4 by fluid, and is further transmitted to the input shaft of the transmission.

When the vehicle speed becomes a predetermined speed or greater, the piston 31 is moved toward the front cover 2, and the friction member 38 is pressed onto the friction surface 2d of the front cover 2. When the friction member 38 is pressed onto the front cover 2, torque of the front cover 2 is transmitted to the driven plate 33 from the piston 31 through the retaining plate 32, the first torsion springs 34 and the second torsion springs 35. The torque transmitted to the driven plate 33 is transmitted to the turbine 5 from the driven plate 33. In other words, the front cover 2 is mechanically coupled to the turbine 5, and the torque of the front cover 2 is directly outputted to the input shaft through the turbine 5.

A step of removing the burrs 13b produced when the impeller hub 13 is frictionally welded to the impeller shell 10 is not performed, and therefore, manufacturing cost can be reduced.

The inner peripheral extending portion 10b is formed on the inner peripheral end part of the impeller shell 10, and thereby, burrs produced when the impeller hub 13 is frictionally welded to the impeller shell 10 are restricted from being produced on the engine side across the impeller shell 10. Therefore, the burrs 13b are not required to be removed, and therefore, the manufacturing step can be simplified.

The nitriding of the piston 31 is performed not for the entire surface but only for the parts configured to be slid with the other members. Therefore, the processing time can be reduced in comparison with that required so far, and thereby, cost reduction is enabled.

The friction surface 2d of the front cover 2 is finished only by cutting without being polished. Further, cutting is not performed for the lateral surface of the front cover 2 except for the friction surface thereof. Therefore, processing time can be reduced, and manufacturing cost can be reduced.

The impeller blades 11 are fixed by swaging, while being inserted into the recessed portions 10a formed on the inner surface of the impeller shell 10. Therefore, brazing is not required for fixing the impeller blades 11 to the impeller shell 10. Accordingly, manufacturing cost can be reduced.

The present invention is not limited to the aforementioned exemplary embodiments, and a variety of changes or modifications can be made without departing from the scope of the present invention.

In the aforementioned exemplary embodiments, the piston is partially processed with surface hardening. However, the piston may be configured to be entirely processed with surface hardening in a processing time shorter than that required so far.

The structure of the lock-up device is not limited to that of the aforementioned exemplary embodiments. For example, the torsion springs may be designed to be disposed only on the outer peripheral side.

According to the torque converter of the present invention, a reduction in processing time can be achieved, while a reduction in manufacturing cost can be implemented.

1. A torque converter, comprising:
a front cover coupled to an engine-side member;
an impeller into which a torque from the front cover is inputted;
a turbine disposed in opposition to the impeller; and
a stator disposed between an inner peripheral part of the impeller and an inner peripheral part of the turbine, the stator being configured to control a flow of an operating fluid flowing from the turbine to the impeller, wherein
the impeller includes
an impeller shell coupled to the front cover;
a plurality of impeller blades disposed inside the impeller shell; and
an impeller hub formed in an axially extending tubular shape, the impeller hub being fixed at an engine-side end part thereof to an inner peripheral part of the impeller shell by friction welding, the impeller hub having a burr produced by the friction welding.

2. The torque converter recited in claim 1, wherein
the impeller shell has an inner peripheral extending portion formed on an inner peripheral end thereof extend and extending to a further inner peripheral side than an inner peripheral surface of the impeller hub, and the inner peripheral extending portion restricting the burr produced by frictionally welding the impeller hub to the impeller shell from being produced on an engine side across the impeller shell.

3. The torque converter recited in claim 1, wherein
the front cover has a friction surface on an impeller-side lateral surface thereof,
the torque converter further includes a lock-up device, the lock-up device being disposed between the front cover and the turbine, the lock-up device directly transmitting the torque from the front cover to the turbine,
the lock-up device includes
a piston having a friction member configured to be pressed onto the friction surface of the front cover, the piston being configured to be axially movable;
an output-side member fixed to the turbine; and
an elastic member elastically coupling the piston and the output-side member in a rotational direction, and
a part of the piston being processed with surface hardening, the processed part being configured to be slid with another member.

4. The torque converter recited in claim 3, wherein
the friction surface of the front cover is not processed with polishing.

5. The torque converter recited in claim 1, wherein
the plurality of impeller blades have a plurality of protrusions on impeller-shell side outer peripheral parts thereof, and the impeller shell has recessed portions into which the plurality of protrusions are inserted on an inner peripheral surface thereof, and
the plurality of impeller blades are fixed to the impeller shell by swaging lateral parts of the recessed portions.
